(19) United States
(12) Patent Application Publication
(10) Pub. No.: US 2021/0064737 A1
(43) Pub. Date: Mar. 4, 2021

(54) Hybrid password formed by an online website which programmatically creates a base password and combines said base password with a secondary password or personal identification number (PIN) entered by the account owner, and together said base password and said user entered password or PIN forms said hybrid password, whose total identity is not known to either said online website nor said account owner

(71) Applicants: Gary William Streuter, Laguna Niguel, CA (US); William Pat Price, Lake Havasu City, AZ (US)

(72) Inventors: Gary William Streuter, Laguna Niguel, CA (US); William Pat Price, Lake Havasu City, AZ (US)

(21) Appl. No.: 16/947,938

(22) Filed: Aug. 25, 2020

Related U.S. Application Data
(60) Provisional application No. 62/892,780, filed on Aug. 28, 2019.

(51) Int. Cl. G06F 21/46; H04L 29/06

(52) U.S. Cl. CPC G06F 21/46; H04L 63/083

(57) ABSTRACT

The present invention describes the creation and use of a hybrid password used to gain access to a password protected online website. The hybrid password is a method whereby an online website, acting as a portal for access to password-protected websites, programmatically generates and stores a base password in the online website portal. A base password is then combined with a secondary password or PIN that is generated by the account owner and known only to the account owner. Together the base password and account owner's PIN form the hybrid password, and becomes the complete password required to provide access to said password protected website. The account owner's password or PIN is not stored in the online website portal and is known only to said account owner.

This application claims priority from Provisional application No. 62/892,780, filed Aug. 28, 2019, the entire contents of which are herewith incorporated by reference.

### FIELD OF INVENTION

This invention relates to providing secure account access to password protected digital websites.

### BACKGROUND

In our modern world, the issue of account and data security has risen to new heights of awareness and concern. This can range from the security of our financial and personal data to even issues of physical security. The concept of right to enter and authorized account access are under siege from relatively new innovations that have been spawned from the Internet and that have made so much information available to anyone with just the press of a button. Want to know something—just Google™ it!

It has long been known that people are the weakest link in any security architecture, and digital account access is no different. The need for a password challenge to account entry has created many different scenarios whereby the user is asked to create what is considered a strong complex password (large number of numbers/letters/symbols or characters). While these long, complex passwords are certainly more difficult to hack, they tend to push users into behaviors that can defeat the good intention of these long and complex behaviors.

### Problem Statement

The sophistication of hackers/criminals has risen to the level whereby we cannot currently be confident in the level of protection we are achieving in securing access to our data or to authorize account access.

### SUMMARY OF THE INVENTION

The intent of the present invention is to secure access to a user's important online accounts by creating a Hybrid Password for each account. The base password is created by an online website acting as a portal to access important user accounts is combined with one or more user entered passwords or PINs created by the account owner. These two elements combine to create a single password which is recognized by the protected account. Neither said online website acting as a portal to a protected account, nor the account owner know the complete password that is required for access to the protected account.

Some of the most common user negative behavior adopted by account users include the following:
They write the password down so they can access it when needed—numerous studies have found large numbers of passwords written on post-it notes and attached to monitors
They will use the same password over, from account to account—increasing the likelihood that a breach of their credentials from one account will yield a breach to others sharing that password
They hesitate to change their password on a timely basis—reluctance to try to remember a new password
They share their password with others, creating a direct breach opportunity

The hybrid password technology disclosed in the present invention is a method whereby two or more separate passwords or PINS are combined to create a single password or pin that can then be used by the account owner to gain access to their accounts. In the hybrid password method, a base password is programmatically generated by an online website acting as a digital portal and is maintained and stored in said online digital portal. Said base password is stored in the portal website's record assigned to the account owner who has registered their account on said online portal website. Said base password is maintained in said online portal website portal website and if used by itself cannot gain access to the account owner's important accounts. The account owner, when assigning access to their important online accounts to the online portal website, is asked to create a secondary password or PIN for the account owner's account on a website. The online portal website will combine the password or PIN entered by the account owner with the programmatically generated base password to create a new and complete user account hybrid password. The complete user account hybrid password is then used to programmatically update the password access requirements of said password protected website, for which said first online website is acting as a portal.

Because the hybrid password is composed of a base password and an account user password or PIN, neither the base password nor the account user's password or Pin can individually be used to access said users account. Simply put, the base password is programmatically generated by said portal website service and stored on said portal website with no visibility of these base passwords provided to said account owner. Conversely, the secondary password/PIN generated by the account owner are known only to said account owner and are never stored or maintained on the online portal website. When the account holder requests access to a protected account via said online portal website, it is the combination of the base password and the account owner entered password/PIN that forms the hybrid password and only the complete hybrid password can be used to gain access to the account owner's protected accounts.

Once the hybrid password has been created and the owner's protected account has been modified to accept said hybrid password, the following procedure is used by the account owner to gain access to their protected accounts:
1. The account owner accesses the portal website that provides access to their protected accounts.
2. The account owner selects the protected account they wish to access
3. The portal website may insert the base password in obfuscated fashion or may only insert said base password without exposing it to said account owner
4. Account owner is then asked to insert enter their user password or PIN associated with said owner's account and not known by said online portal website
5. Account holder enters their user password or PIN and launches an access request to said protected account using said Hybrid Password
6. Said protected account receives said Hybrid Password, which is a combination of said base password(s) and the account owner's passwords or PINs and seeks to verify a match of the Hybrid Password to its database of passwords assigned to said account owners account
7. If said protected account matches said Hybrid Password to the current password stored in the protected accounts database and assigned to that account owner, access is granted
8. In some cases, acceptance of said Hybrid Password by the protected account may required the account owner to also perform 2^{nd} factor authorizations beyond the password match before account access is granted
9. If the protected account cannot match said Hybrid Password to the current password stored in said protected account, the account access request is denied

The user's accounts are updated with the hybrid password and thus, neither the secondary password/PIN known by the user or the base password known by the portal website is able by itself to authorize account access. Simply put, the authorized account owner and said first website acting as a portal to the users accounts only knows a portion of the hybrid password required to access their accounts. The user's password and the first website generated base password must be combined in the proper fashion for access to be granted by their important accounts.

### Definitions

PIN: A personal identification number (PIN) is a secure alphanumeric or numeric code used for authenticated access to a system and can incorporate a variable number of numeric and alpha characters or symbols
Local/Mobile Computing Device: Personal computer, Smartphone, Tablet or similar mobile devices containing a processor, memory and storage, and capable of addressing a Remote Network Server/Web Server
Base Password: A programmatically generated password of one or more characters that can consist of capital or lower-case letters, numbers or symbols and is obfuscated or hidden when displayed to the account owner
Users Password or PIN: A Users password or PIN is a secure alphanumeric or numeric code entered by the account owner and never known or maintained by the online website acting as a portal
Hybrid Password: A combination of a programmatically created base password with one or more passwords or PINs entered by the account owner, creating said Hybrid Password.
Password or PIN: For purposes of this disclosure, these terms may be used interchangeably.
Protected Account: An important user account that requires the correct password in order to gain access.
First Online Website Acting as a Portal: An online website that is used to launch access to other important password protected online websites
Programmatically Created Base Password: A password segment which is programmatically created by an online website portal

### BRIEF DESCRIPTION OF THE DRAWINGS

FIG. 1 depicts a prior art 20-character password field.

FIG. 2 depicts a prior art 6-character PIN.

FIG. 3 depicts the process of pruning black characters from a password field showing the final pruned password.

FIG. 4 depicts a 26-character hybrid password where the base password was not pruned, and the user 6-digit pin is appended.

FIG. 5 depicts a flow chart showing the steps for generating a random base password and saving it and soliciting the associated protected website URL.

FIG. 6 depicts a flow chart showing the sequence when the user wants to log into a protected website.

FIG. 7 shows an operation of merging passwords.

### EMBODIMENTS

Reference will now be made in detail to various embodiments, examples of which are illustrated in the accompanying drawings. Wherever possible, the same reference numbers will be used throughout the drawings to refer to the same or like parts.

In a first embodiment, a website portal generates a randomized base password and then solicits the URL for a website that will be protected by the hybrid password made up of the random base password and a pin entered by the user. The random base password and the URL for the protected website is saved in the website portal. The user's pin is never saved in the website portal. The user never sees the random base password and the website portal has no knowledge of the user's pin.

In a related embodiment, the website will prune any blank character spaces at the end of the random base password such that only valid characters will be present in the base password.

In another related embodiment, the website will merge the users pin within the base password by inserting characters/numbers from the pin between characters that make up the random password.

In another related embodiment, the portal website always generates a randomized portion of a hidden password allowing the user to use the same user's pin or the same user's password portion for all of their accounts. Even if a hacker guesses the user correct pin that pin will only allow access to a single user's account.

In another related embodiment, the portal website when receiving said user's pin or said user's password portion measures and remembers the time delay between each entered character of user's entered pin or each entered character of user's entered password portion. The portal website remembers the time delay between each of the entered characters over a period of a predetermined number of entries of the user's pin or password portion. After the period of the predetermined number of entries of the user's pin or password portion has been exceeded, the portal website will average the time between the characters of user's pin or password portion and will compare the time period between the characters of user's pin or password portion entry and if the time difference between a new login attempt and the average time period between the characters of user's pin or password portion entry vary more than a predetermined amount of time the login attempt will be rejected.

### DETAILED DESCRIPTION OF THE EMBODIMENTS AND DRAWINGS

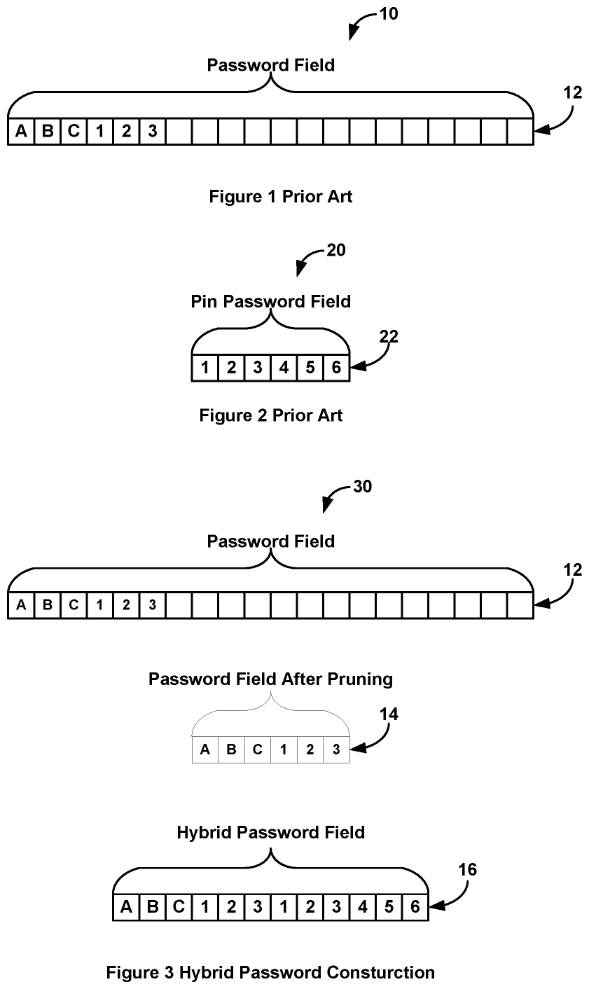

Now referencing FIG. 1 where 10 depicts a prior art 20-character base password field. Shown in the password field is shown a password of “ABC123”. Note that the balance of the password field is ASCII null characters which by definition are binary zeros or ASCII spaces which by definition are hexadecimal ox20.

Now referencing FIG. 2 where 20 depicts a prior art PIN password field. Multiple websites use a pin code instead of a alpha numeric string of characters. Microsoft™ uses pin codes to log into user's computers.

Now referencing FIG. 3 where 30 depicts the sequence of creating a hybrid password is shown. In this figure the website portal retrieves the base password then the user enters his pin. In one embodiment, any trailing null characters or spaces are pruned then the pin is appended the base password shown as 16 in FIG. 3.

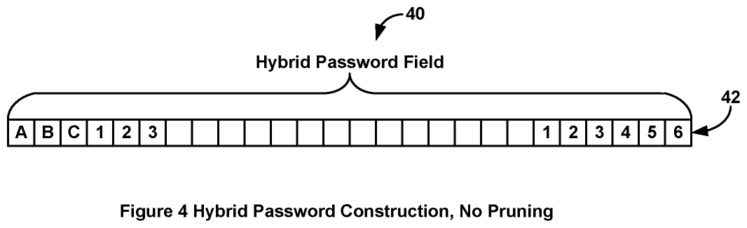

Now referencing FIG. 4 where 40 depicts a 20-character base password (“ABC123”) with a six-digit pin appended to the 20-character base password making a 26-character string.

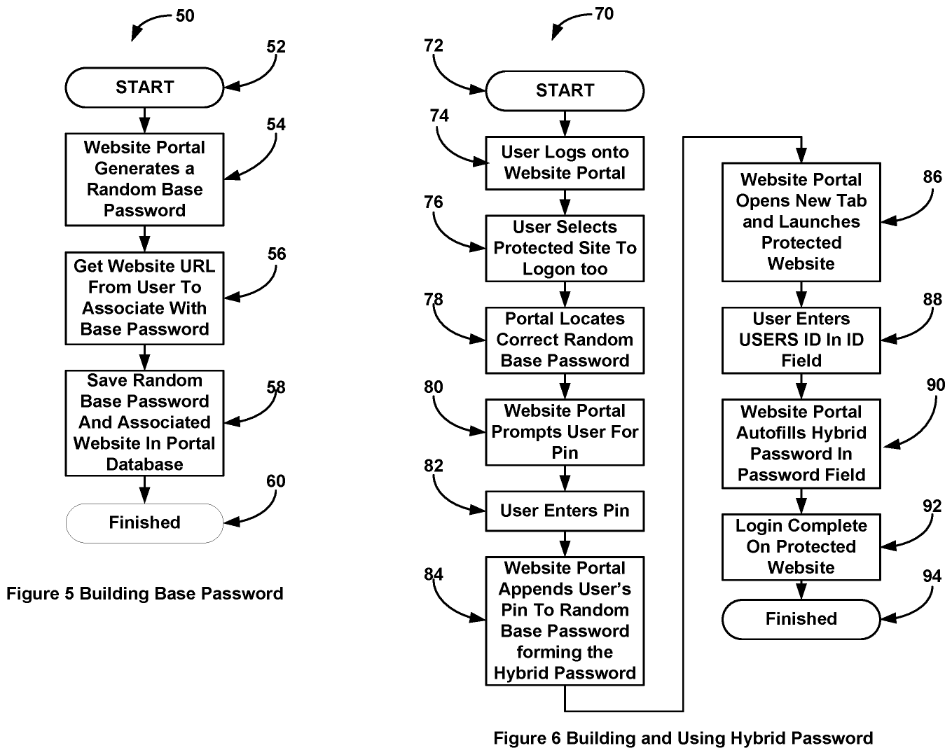

Now referencing FIG. 5, where 50 depicts a logic flowchart showing the sequence used to generate a random base password and save the random base password with the associated URL for the protected website. In this flowchart, the logic flow starts at step 54 where a random base password is generated after which control falls through to step 56. Step 56 solicits the URL for the protected website after which control falls through to step 58. Step 58 saves the random base password and the protected website it is associated with in the website portal after which control falls through to step 60 Finished.

Not referencing FIG. 6, where 70 depicts a logic flow chart showing the sequence used for a user to log onto a protected website. In this logic flowchart, the flow starts at step 72 and control falls through to step 74.

Step 74, User Logs onto website Portal. Once the user logs onto the Website Portal control falls through to step 76. This step displays a list of the user's protected website. The user then selects the protected website he wants to log onto. Once he makes the selection control falls through to step 78.

Step 78, Website Portal locates the correct random base password. This step locates the random base password associated with the user's selected protected website after which control falls through to step 80.

Step 80, Website Portal Prompts User For Pin, This step solicits the user to enter his pin code after which control falls through to step 82.

Step 82 User Enters Pin. In some embodiments the pin entered by the user may be all numeric characters or may be alpha-numeric characters and may contain symbols such as “#” or any other non-alpha character. After the user's pin has been entered control falls through to step 84.

Step 84, Website Portal Appends User's Pin To Random Base Password forming the Hybrid Password. This step forms the hybrid password by appending the user's pin to the random base password. This step may also prune any null or space characters from the end of the random base password and from the end of the user's pin prior to appending the user's pin to the end of the random base password forming the hybrid password after which control falls through to step 86.

Step 86, Website Portal Opens New Tab and Launches Protected Website. This step opens a new tab on the user's browser and launches the user's protected website in the new tab after which control falls through to step 88.

Step 88, User Enters User's ID in ID field. The user, in this step, selects the login option on the protected website's page and enters his User ID after which control falls through to step 90.

Step 90, Website Portal Auto fills Hybrid Password in Password Field. This step copies the hybrid password into the password field in the new tab and obfuscates it so that the user cannot directly view the random base password after which control falls through to step 92.

Step 92, Login Complete On Protected Website. This step completes the log onto sequence for the user log onto a protected website and control falls through to step 94, Finished.

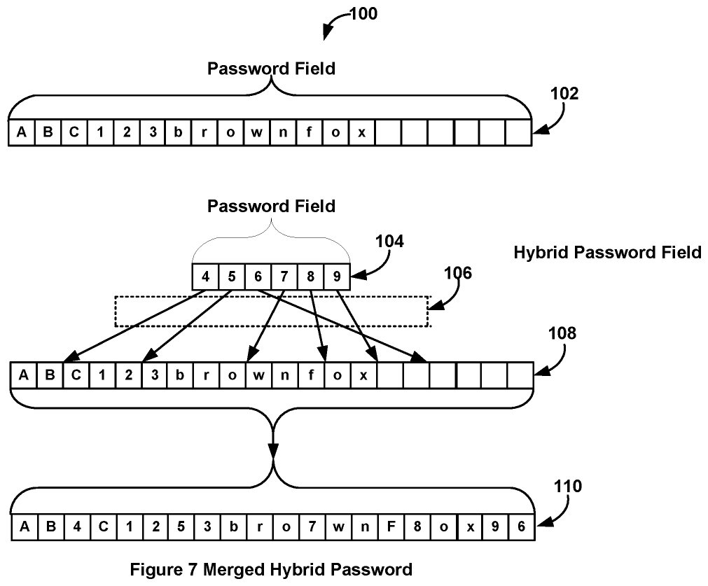

Now referencing FIG. 7 where 100 depicts the construction sequence to merge a lain code into the randomized base password.

In this FIG. 102 represents the generated randomized base password. 104 represents the pin code entered by the user. 106 represents the merge pattern used to merge the pin code, character by character, into the randomized base password. Note that in this example of merge pattern 106, the first character of the entered pin code will be placed between characters two and three of the randomized base password and the second character of the entered pin code will be inserted between the fifth and sixth characters of the randomized password. 110 represents the final base password that will auto filled into the password field and be obfuscated.

We claim the following:

1. A method whereby a hybrid password is formed by combining a programmatically generated base password with a user generated password or Personal Identification Number (PIN) used to access an account located on an online website.

2. The method of claim 1 whereby the programmatically generated base password is created by an online website acting as a portal to other password protected websites.

3. The method of claim 1 whereby the programmatically generated base password is unknown to the owner of an online portal account.

4. The method of claim 1 whereby the programmatically generated base password and the user generated password or PIN must consist of a minimum of 2 characters and an unlimited maximum amount of characters.

5. The method of claim 1 whereby the programmatically generated base password may contain any combination of upper or lower-case alpha characters, numbers, or symbols.

6. The method of claim 1 whereby the user generated password or PIN is never retained by said online website acting as a portal to password protected websites.

7. The method of claim 1 whereby the user generated password or PIN is entered to the online website acting as a portal to password protected website by the account owner.

8. The method of claim 1 whereby the programmatically generated password when combined with the user generated password or PIN form a single password for gaining access to a password protected website.

9. A method for limiting access by a hacker gaining access to a user's password to all websites where said user has an account to just a single website comprising:
a. a portal website accessed by said user to protect said user's accounts accessible only through said portal website where said portal website generates a different randomized password portion that remains unknown to said user, and
b. said user enters said user's portion of said password concatenated or merged into said password portion generated by said portal website, said user's portion of said password remains unknown to said portal website, and
c. said user may enter the same user's portion of said password for any of user's said website accounts without fear of a hacker being able to access more than one of said user's website accounts because said portal website has generated a different randomized portion of said portal websites password portion.

10. The method of claim 9 where said portal website merges said user's portion of said user's pin or user's password portion by interspersing said user's portion of said user's pin or user's password portion of said user's password.

11. The method of claim 10 where said password portion generated by said portal website may consist of printable ASC-II characters or may consist of non-printable characters or may consist of a combination of said non-printable characters and printable ACI-II characters.

12. The method of claim 11 whereby said portal website measures the difference in time between the characters of said user's pin or password portion being entered by said user, and said portal website averages the time periods between said characters of said user's pin or of said user's password portion being entered, and said portal website saves said time period averages of a predetermined number of said user's login attempts.

13. The method of claim 12 where said portal website measures the difference in time between the characters of said user's pin or password portion being entered and compares said time periods against the average of said saved time period averages and if a difference is detected between the time period of characters of said just entered against the saved time period averages of characters of said user's pin or password are different by a predetermined time period, said user's login is rejected.
